(19) United States
(12) Patent Application Publication
(10) Pub. No.: US 2022/0134455 A1
(43) Pub. Date: May 5, 2022

(54) Superalloy Saw Blade

(71) Applicant: WIKUS-Sägenfabrik Wilhelm H. Kullmann GmbH & Co. KG, Spangenberg (DE)

(72) Inventor: Jörg H. Kullmann, Spangenberg (DE)

(21) Appl. No.: 17/516,748

(22) Filed: Nov. 2, 2021

(30) Foreign Application Priority Data
Nov. 3, 2020 (DE) 10 2020 128 920.0

(51) Int. Cl. B23D 61/12; B23D 61/14

(52) U.S. Cl. CPC B23D 61/127; B23D 61/123; B23D 61/14

(57) ABSTRACT

A separating tool (1) including a tooth supporting body (2) and a plurality of teeth (3) being arranged at the tooth supporting body (2) serves to separate workpieces of steel, the workpieces having a high temperature. The tooth supporting body (2) is made of a superalloy (10).

### CROSS REFERENCE TO RELATED APPLICATIONS

This application claims priority to co-pending German Patent Application No. DE 10 2020 128 920.0 filed Nov. 3, 2020.

### FIELD OF THE INVENTION

The present invention relates to the technical field of steel production and especially of separating blanks for workpieces of steel having high temperatures of at least 750° C.

Such high temperatures prevail after the production and heat treatment of blanks for workpieces of steel. These blanks for workpieces are especially intended to be then separated and further processed.

### BACKGROUND OF THE INVENTION

It is generally known in the prior art that separating of blanks for workpieces of steel with a temperature of at least 750° C. is conducted with an oxygen lance. This causes high emissions also requiring extraction. This use of an oxygen lance is dangerous and unhealthy for the operator despite the necessarily required protective clothing.

It is also generally known in the prior art to conduct such a separating method with a separating disk (cutting disk). The diameter of the separating disk has to be chosen to be very big when it is desired to separate workpieces of different diameters therewith. Alternatively, different separating disks having different diameters have to be used for different workpieces having different diameters. This causes additional expenditure when changing the separating disk. The separating disk has a great wear and tear, and it has to be often replaced in such demanding applications.

A circular saw blade including a tooth supporting body and a plurality of teeth being located at the tooth supporting body is known from German patent application DE 16 52 756 A. The circular saw blade serves to separate rolled-warm steals with a temperature in an order of approximately 700 to 1,000° C. For this purpose, the teeth and the gaps between the teeth have a special geometry.

A circular saw blade including a tooth supporting body and a plurality of teeth being located at the tooth supporting body is known from Chinese patent application CN 109 530 806 A. The teeth include cutting inserts being made of a superalloy.

### SUMMARY OF THE INVENTION

The present invention relates to a separating tool including a tooth supporting body and a plurality of teeth being arranged at the tooth supporting body. The tooth supporting body is made of a superalloy.

The present invention furthermore relates to a tooth supporting body for a separating tool which includes the tooth supporting body and a plurality of teeth being arranged at the tooth supporting body. The tooth supporting body is made of a superalloy.

The present invention also relates to the use of a separating tool, dividing tool or chipping tool including a tooth supporting body being made of a superalloy and a plurality of teeth being arranged at the tooth supporting body as a high-temperature steel-separating tool for separating a blank for a workpiece made of steel with a temperature of at least 750° C. The present invention furthermore relates to the use of a chipping tool including a tooth supporting body being made of a superalloy and a plurality of teeth being arranged at the tooth supporting body as an underwater workpiece separating tool for separating a workpiece underwater or as a tool for separating a workpiece with pure water as cooling lubricant.

The new separating tool is suitable for separating workpieces of steel having a high temperature safely, efficiently and environmentally friendly.

Definitions

Separating tool: A separating tool is to understood in this application in accordance with German standard DIN 8588 as a tool with which the production process of separating is conducted. According to this standard, among other things, dividing, chipping with geometrically defined cutting edges and chipping with geometrically undefined cutting edges belong to separating.

Dividing: Dividing is to be understood in this application in accordance with German standard DIN 8588 as mechanically separating workpieces without producing chips.

Chipping: Chipping (or machining) is to be understood in this application in accordance with German standard DIN 8588 as mechanically separating workpieces while producing chips.

Chipping tool: In chipping (or machining), one distinguishes between chipping with geometrically defined cutting edges and chipping with geometrically undefined cutting edges. According to German standard DIN 8589-6, sawing belongs to chipping with geometrically defined cutting edges. According to this standard, sawing does not belong to chipping with geometrically undefined cutting edges. For this reason, the correct generalizing term of a separating tool or a chipping tool is used in this application. Practically, chipping tools from this technical field including cutting particles are nevertheless mostly designated as saw bands and saw blades, respectively.

Saw blade: A saw blade is to be understood in this application as an elongated saw band, a hacksaw blade, a circular saw blade, a machine saw blades, a reciprocating saw blade, a jig saw blade or any other possible type of a saw blade.

Tooth supporting body: A tooth supporting body is to be understood in this application as the part of the chipping tool at which the teeth of the chipping tool are arranged. This is also often designated as the “base body” of the chipping tool. The term “tooth supporting body” is however intended to better express that this is the part of the chipping tool which itself cannot be designated as a tooth, but instead the part at which the teeth are arranged. It is to be taken into account that there are differences between the functional and the material differentiation between the tooth supporting body and the teeth. Functionally, the tooth begins with its tooth base in the region of the tooth gullet. This tooth base however is often made of the same material as the tooth supporting body, and it is designed as one piece therewith. In other words, a part of this material fulfills the function of the tooth supporting body, and another part fulfills the function of the tooth base and thus of the tooth. The differentiation with respect to the material is then realized further away from the tooth supporting body in the region of the tip of the tooth.

Superalloy: A superalloy is to be understood in this application in accordance with the accepted specialized definition as a metallic material having a complex composition (with a base of iron, nickel, platinum, chromium or cobalt and additions of the elements Co, Ni, Fe, Cr, Mo, W,

Re, Ru, Ta, Nb, Al, Ti, Mn, Zr, C and/or B) for high-temperature applications. A superalloy has a great high-temperature strength and a great creep resistance. A nickel-based superalloy is an example.

Heat insulation layer: A heat insulation layer is to be understood in this application as a coating being applied to a material which, due to its low heat conductivity, prevents the temperature of the material increasing too much during high-temperature applications of the workpiece. Examples are zirconium dioxide and gadolinium dioxide.

Hard material layer: A hard material layer is to be understood in this application as a coating being applied to a material, the coating consisting of a hard material. The hardness of the hard material layer is at least 2,000 HV 1. The hard material layer furthermore has a great high-temperature strength. AlCrN and nanocomposite layers are examples.

Further description

A completely new type of separating tool is used for separating hot workpieces of steel. This especially applies to separating blanks for workpieces of steel during steel production.

Although the blanks for the workpieces have very high temperatures of at least 750° C., separating is realized by a separating tool, a dividing tool and a chipping tool, respectively. In the prior art, it has been considered impossible to conduct this method with a chipping tool due to the high temperatures. This prejudice is now overcome for the first time by the tooth supporting body being made of a superalloy.

The superalloy has a sufficiently great high-temperature strength and creep resistance and is thus suitable for such a high-temperature application. The superalloy is also characterized by the fact that it still is structurally durable (high-temperature resistant) at approximately 90% of its melting temperature. Therefore, the new tool may also be designated as superalloy separating tool.

The tooth supporting body may be additionally coated with a heat insulation layer. This also leads to the separating tool having the required structural durability in the high-temperature application in question.

The tooth supporting body may be additionally coated with a hard material layer. This also leads to the separating tool having the required structural durability in the high-temperature application in question.

In addition to the tooth supporting body, the teeth may be completely or partly made of the superalloy and/or coated with the heat insulation layer and/or the hard material layer. However, the tooth tips and/or the cutting edges are especially made of a different material and are not coated with a heat insulation layer, respectively. However, they may be coated with the hard material layer.

Separating at the prevailing high temperatures occurs differently than it is usually the case at substantially lower temperatures during chipping. Substantially less chips or no chips at all are formed. At least a part of the separating process occurs rather in the sense of pushing out the partly flowable material of the blank for the workpiece of steel. For this reason, the present application uses the term of a separating tool. However, this does not change the fact that the tool is one having the structural features of a chipping tool by definition.

The new separating tool makes it possible to further process steel at high temperatures directly after its production and heat treatment without having to let it cool down to room temperature. Thus, the blanks for the workpieces do not require a complex cooling down process for separating and thus do not have to be re-heated to reach the processing temperature for further processing them in the following. This results in a reduction of time, energy and costs. Furthermore, analyzing steps concerning the blanks for the workpieces for the following examinations and analysis can be conducted earlier.

The separating tool especially is a sawing tool, especially a saw band or a circular saw blade. When the separating tool includes teeth having geometrically undefined cutting edges, according to the standard, this no sawing tool or saw blade, but instead a different chipping tool. However, when one assumes that no chips are produced during use of the separating tool due to the high temperatures, such a tool is designated as dividing tool according to the standard. However, this does not change the geometry.

The separating tool especially does not serve to conduct one of the other methods of chipping with geometrically defined cutting edges according to German standard DIN 8589. This especially applies to turning, drilling and milling.

The superalloy allows for use of the separating tool at temperatures of at least approximately 750° C., especially at least approximately 800° C., especially at least approximately 900° C., especially at least approximately 1,000° C., especially between approximately 800° C. and 1,400° C., especially between approximately 900° C. and 1,300° C., especially between approximately 1,000° C. and 1,300° C. The strength and creep resistance of the superalloy at these temperatures is sufficient to be able to conduct the separating method without substantial damages of the tool.

The superalloy also is particularly resistant to corrosion.

The superalloy may be a nickel-based superalloy. Nickel is the main alloying element in a nickel-based superalloy. There is at least one other chemical element as alloying element. Such a nickel-based superalloy has the required properties for fulfilling the desired purpose. The melting temperature is at approximately 1,300° C. The heat resistance and the allowable temperature of application thus is at approximately 1,200° C.

The heat insulation layer may be especially zirconium dioxide, gadolinium dioxide, mullite, lanthanum zirconate or yttrium oxide stabilized zirconium oxide. The heat resistance of the heat insulation layer is especially at at least 800° C., especially at at least 900° C., especially between approximately 1,000° C. and 1,400° C. The hard material layer is made of a hard material. Especially, this may be TiN, TiCN, TiAIN, TiAICN, AITiN, AlTiCrN, AlCrN, ZrCrN, CrN—Cr, CrN, Cr₂N, BCN, TiBN, TiB₂ or DLC. However, this may also be a nanocomposite layer. The hardness of the hard material layer is especially in a region between approximately 2,000 HV 1 and 5,000 HV 1, especially between approximately 3,000 HV 1 and 4,500 HV 1. The heat resistance of the hard material layer is especially at at least 800° C., especially at at least 900° C., especially between approximately 1,000° C. and 1,200° C.

Suitable measures concerning the material of the teeth, of the tooth tips and of the cutting edges are taken to ensure that the entire separating tool—and not only the tooth supporting body -has the required strength and creep resistance at the prevailing high temperatures. These measures differ depending on the design of the separating tool, for example as a saw blade including protrusions of the superalloy and carbide inserts being connected thereto or as a separating tool including tooth tips of the superalloy being partly covered by cutting particles to form a plurality of geometrically undefined cutting edges. Details to this are described hereinbelow. It is preferred that the heat resistance of the entire separating tool is between approximately 1,000° C. and 1,300° C.

The teeth of the separating tool may each include a tooth tip including a geometrically defined cutting edge. The method conducted with this separating tool thus belongs to chipping with a geometrically defined cutting edge. This kind of chipping (or machining) is also designated as sawing. The separating tool thus is a saw blade. The saw blade may be designed as a saw band, a circular saw blade or a saw blade having a different shape. In case it is a saw band, this may be designated as superalloy saw band.

The cutting edge of the tooth may include a rake surface having a negative rake angle. It has been found out that such a negative rake angle compared to a positive rake angle leads to substantially improved cutting results. The reason for this is that material is better driven out from the cutting channel with a rake surface with a negative rake angle. However, at the prevailing high temperatures, this is less chipping, but rather driving out and displacing, respectively, the steel from the cutting channel.

The tooth tip may be coated with a (or the) hard material layer. The hard material layer leads to a reduction of the temperature sensitivity of the tooth tip such that not only the tooth supporting body due to the use of the superalloy, but also the tooth tip is suitable for this application at the prevailing high temperatures. The hard material layer furthermore improves the hardness and the wear resistance of the teeth. Moreover, the hard material layer provides effective corrosion protection.

The hard material layer may not only extend over the tooth tip, but also over another part of the tooth. The hard material layer may also extend over the entire tooth or even completely or partly over the tooth supporting body. In these cases, the entire tooth attains the desired hardness due to the hard material layer. The desired temperature resistance exists due to the superalloy in combination with the heat insulation layer and/or the hard material layer.

Each of the teeth may be formed by a protrusion and an insert, the protrusion being arranged at the tooth supporting body and the insert being arranged at the protrusion. The “arrangement” of the protrusion at the tooth supporting body is also be understood as a one-piece design. Thus, the protrusion is also made of the superalloy. The insert then forms the tooth tip and the cutting edge of the tooth.

The insert may be made of carbide (hard metal). In this case, one speaks of a carbide tipped saw blade. The carbide is especially a steel being alloyed with tungsten and/or cobalt. Such hard metals especially have a temperature resistance of up to approximately 900° C.

Instead of carbide, the inserts may also consist of high-speed steel (HSS). High-speed steel has a temperature resistance of up to approximately 600° C. To increase the temperature resistance of the inserts, they are coated with a hard material layer and/or a heat insulation layer.

The insert may be connected to the protrusion by welding or high-temperature brazing or soldering. These connecting methods ensure the required fixed connection between the protrusion and the insert also at the prevailing high temperatures.

Instead of the above-described geometrically defined cutting edges, the teeth may also each include a tooth tip being partly covered with cutting particles to form a plurality of geometrically undefined cutting edges. The cutting particles have the required hardness and heat resistance. Especially, they may be cubic boron nitride (CBN), cutting ceramics, carbide or combinations thereof.

The separating tool may be a so-called bimetal saw blade, especially a bimetal saw band. Such a bimetal saw band includes a carrier band section and an edge wire section being connected thereto. The edge wire section forms the tooth tips and the cutting edges of the teeth. In this case, the carrier band section is the tooth supporting body. Thus, the carrier band section is made of the superalloy, and it may be covered with the heat insulation layer and/or the hard material layer.

In addition of the aspect of the great high-temperature strength and creep resistance when separating hot steel, the tooth supporting body of the superalloy also fulfills another purpose in a different application. This application is the separation of a workpiece underwater or using pure water as cooling lubricant. The present invention thus also relates to the use of a separating tool including a tooth supporting body of a superalloy and a plurality of teeth being arranged at the tooth supporting body as an underwater workpiece separating tool for separating a workpiece underwater or as a tool for separating a workpiece with pure water as cooling lubricant.

Due to the great resistance to corrosion of the superalloy, the new separating tool is especially suitable for a use underwater. Such a use takes place, for example, for separating contaminated or highly contaminated components—e.g. heat exchangers, pipes, steam generators or reactor pressure vessels—when dismantling nuclear power plants. Another exemplary application is the underwater repair of the steel construction of wind turbines or in the fields of the oil industry or the gas industry. When the separating tool does not get in contact with a workpiece for a longer period of time and is exposed to water overnight or even over the weekend or a company holiday, there is an increased danger of corrosion. This danger is counteracted by the superalloy.

Another exemplary application is the chipping (machining) of workpieces for which only pure water can be used as cooling lubricant since e.g. oil—which is usually added to the cooling medium—would contaminate the workpiece and would enter into the surface of the workpiece to be separated and damage the surface or negatively change the appearance of the surface, respectively.

It is preferred that the entire separating tool has this resistance to corrosion. When the separating tool is a bimetal saw band and this is destined to be used underwater, the edge wire does not have to be made of the high-temperature resistant material or coated with a high-temperature resistant coating. For example, it may be a tool steel or a high-speed steel having the desired resistance to corrosion. In this case, it is the resistance to corrosion and not the high-temperature strength of the superalloy that is made use of.

The superalloy especially has a comparatively great chrome content. Especially, the chrome content may be at least approximately 12%. This results in an especially good resistance to corrosion.

The teeth of the separating tool and of the chipping tool, respectively, may be arranged at identical distances between one another—i.e. at a constant division—at the tooth supporting body. However, it is also possible that the teeth are arranged at varying differences between one another—i.e. at a variable division—at the tooth supporting body. The teeth may be unset teeth. However, it is also possible that the teeth are set teeth.

The teeth may be designed and arranged according to the so-called group technology. This means that a repeated group of different teeth is arranged at the tooth supporting body. The teeth within the group have different heights and/or widths such that the teeth fulfill different functions. However, it is also possible that the teeth are designed in the sense of the so-called pre-cutter and finishing cutter technology.

The new band-shaped separating tool (“saw band”) is used in a separating machine (“saw machine”) for separating a workpiece of steel. To allow for separating a blank for a workpiece of steel during steel production, during which the workpiece has a temperature of at least 750° C., the saw machine includes a cooling apparatus for cooling a region of the saw machine outside of the sawing region in which the workpiece is separated. Cooling is realized by a suitable cooling medium. For example, the cooling medium may be water, oil or air. The saw band is clamped in the saw machine with a suitable band tension to allow for a compensation of the change of the length due to heat expansion.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if a rake surface is mentioned, this is to be understood such that there is exactly one rake surface or there are two rake surfaces or more rake surfaces. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with respect to preferred exemplary embodiments illustrated in the drawings.

FIG. 1 illustrates a side view of a part of a first exemplary embodiment of the new band-shaped separating tool.

FIG. 2 illustrates a view of the separating tool according to FIG. 1 from above.

FIG. 3 illustrates a side view of a part of a second exemplary embodiment of the new band-shaped separating tool.

FIG. 4 illustrates a detailed view of a part of the separating tool according to FIG. 3.

FIG. 5 illustrates a side view of a part of a third exemplary embodiment of the new band-shaped separating tool.

FIG. 6 illustrates a side view of a part of a fourth exemplary embodiment of the new circular separating tool.

FIG. 7 illustrates the detail A from FIG. 6.

### DETAILED DESCRIPTION

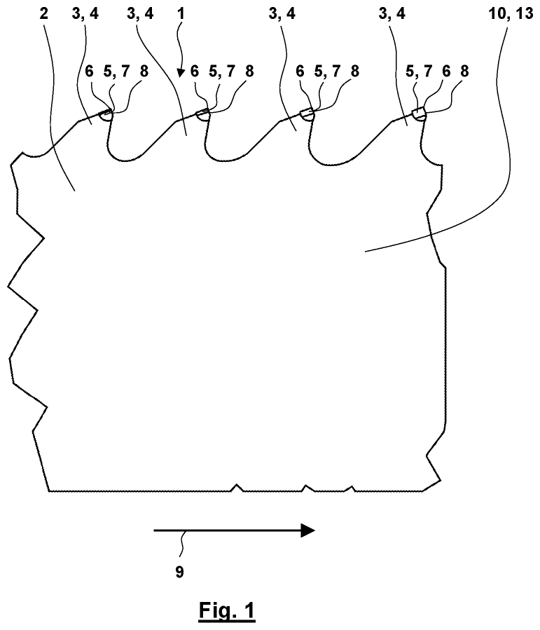

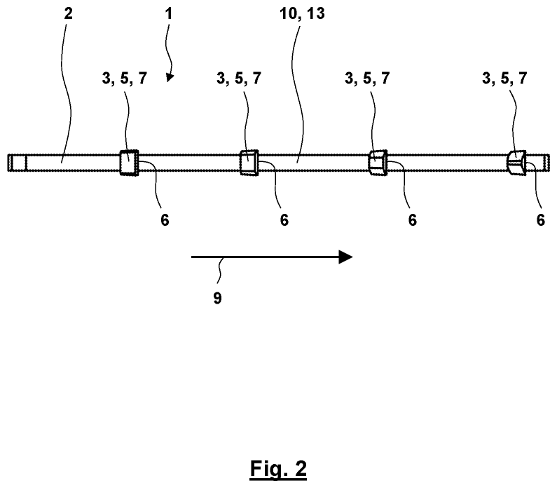

FIGS. 1 and 2 illustrate views of a section of a first exemplary embodiment of a new separating tool 1, which in this case is designed to be band-shaped. The section is indicated by respective truncation lines in the left and right part of the illustration of FIG. 1. Such a band-shaped separating tool 1 is often designated as saw band in the prior art.

The illustrations of these figures and the following figures are true to scale such that the geometric relations between the elements of the separating tool 1 can be derived from the figures.

The separating tool 1 includes a tooth supporting body 2 and a plurality of teeth 3 being arranged at the tooth supporting body 2. The teeth 3 may be designed to be completely or partly one piece with the tooth supporting body 2. In the present case, the teeth 3 are arranged in repeated groups of geometrically differently designed teeth 3 along the tooth supporting body 2. The teeth 3 are here arranged at the tooth supporting body 2 with a variable division (i.e. varying distances between them). However, the teeth 3 could also not be arranged according to the group technology and/or with a constant division (i.e. identical distances between them) at the tooth supporting body 2.

The teeth 3 each include a tooth tip 7 being arranged at the end of the respective tooth 3 opposite to the tooth supporting body 2. The teeth 3 are each formed by a protrusion 4 of the tooth supporting body 2 as well as an insert 5. The insert 5 is made of a material being harder than the material of the protrusions 4 and of the tooth supporting body 2 of the separating tool 1.

Preferably, the material of the insert 5 is carbide (hard metal). However, this could also be a different material. The inserts 5 are fixedly connected to the respective associated protrusion 4, especially by brazing, soldering or welding.

The cutting edge 6 of the tooth 3 is formed at the insert 5. In the present case, this is a cutting edge 6 being geometrically defined. The cutting edge 6 includes a rake surface 8 having a negative rake angle. The sense of direction of band movement 9 of the separating tool 1 here goes from left to right. However, the rake angle could also be positive or 0°.

The new separating tool 1 has a special material composition which achieves that it is possible to separate workpieces of steel having a high temperature safely, efficiently and environmentally friendly by the separating tool 1. Another possible application if they use of the separating tool 1 for separating a workpiece underwater or as a tool for separating a workpiece with pure water as cooling lubricant.

For this purpose, the tooth supporting body 2 is made of a superalloy 10. The protrusions 4 are also made of the superalloy 10. The tooth supporting body 2 may be additionally coated with a heat insulation layer 11 and/or a hard material layer 12. The layers 11, 12 are not present in the embodiment of the separating tool 1 according to FIGS. 1 and 2 such that they do not include the reference numerals 11 and 12. It is referred to the following drawings in which the layers 11, 12 are partly present.

In the present example, the superalloy 10 is a nickel-based superalloy 13. However, it could also be a different superalloy 10.

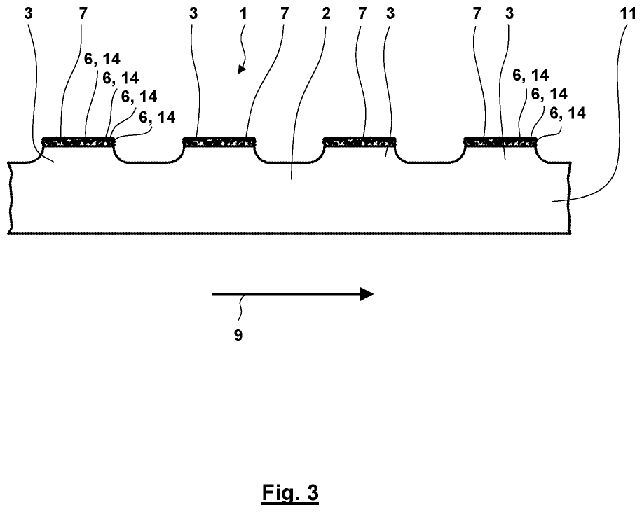

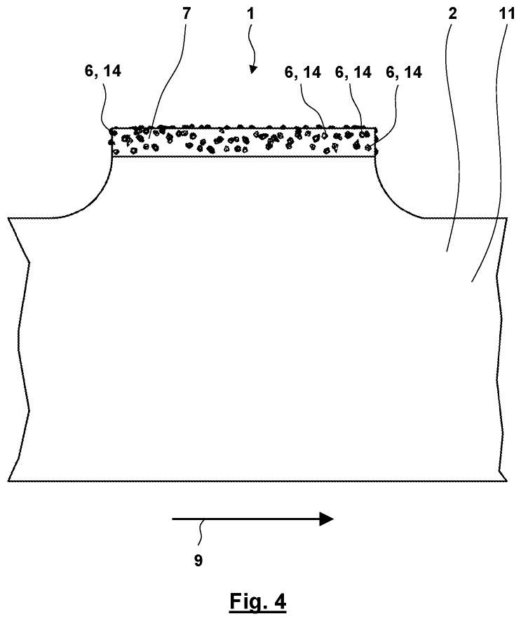

FIGS. 3 and 4 illustrate another exemplary embodiment of the new separating tool 1 which does not fall under the wording of the independent claims. Once again, this is a separating tool 1 including an elongated band-shaped tooth supporting body 2.

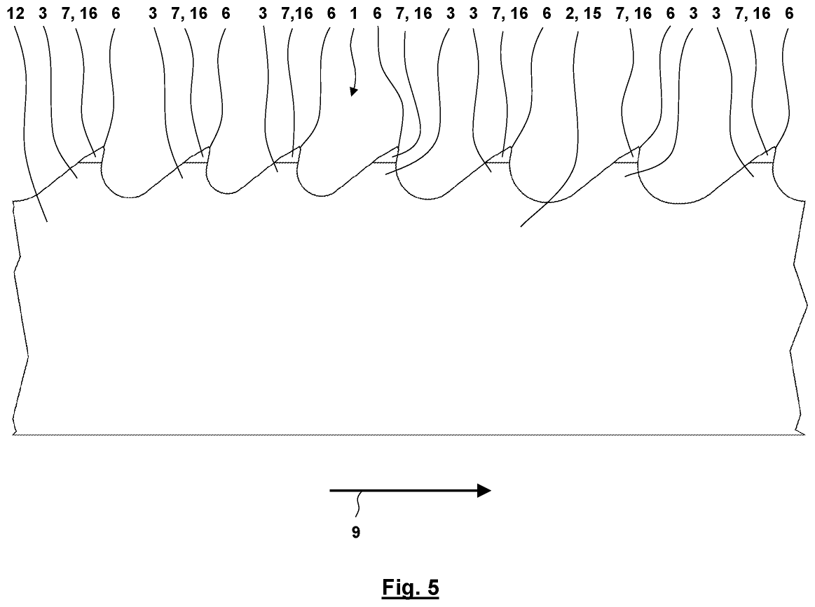

In contrast to the embodiment of the separating tool 1 according to FIGS. 1, 2, the teeth 3 each include a tooth tip 7 being partly covered by cutting particles 14 to form a plurality of geometrically undefined cutting edges 6. The teeth 3 are arranged along the tooth supporting body 2 with a constant division (i.e. identical distances between them). In this embodiment of the separating tool 1, the tooth supporting body 2 is not made of the superalloy 10, but it is coated with a heat insulation layer 11. However, it would also be possible that the tooth supporting body 2 was additionally made of the superalloy 10 and/or was coated with a hard material layer 12. FIG. 5 illustrates another exemplary embodiment of the new separating tool 1 which does not fall under the wording of the independent claims. In this case, the separating tool 1 is a bimetal saw band including a carrier band section 15 and an edge wire section 16 being connected thereto.

The edge wire section 16 forms the tooth tips 7 and the cutting edges 6 of the teeth 3. The rest of the originally continuously band-shaped edge wire section 6 has been removed by milling.

The carrier band section 15 is coated with the hard material layer 12. In this case, the carrier band section 15 is not made of the superalloy 10. However, it could be made of the superalloy 10 and/or coated with a heat insulation layer 11.

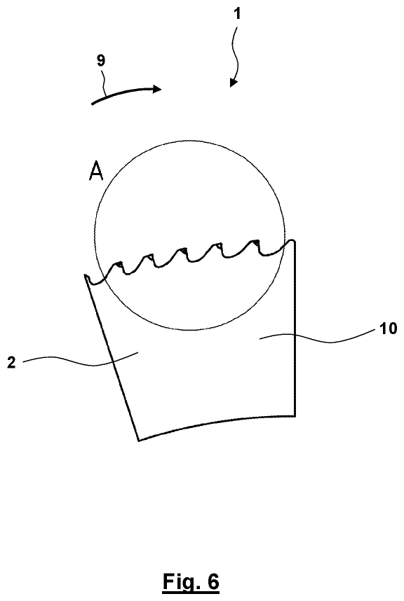

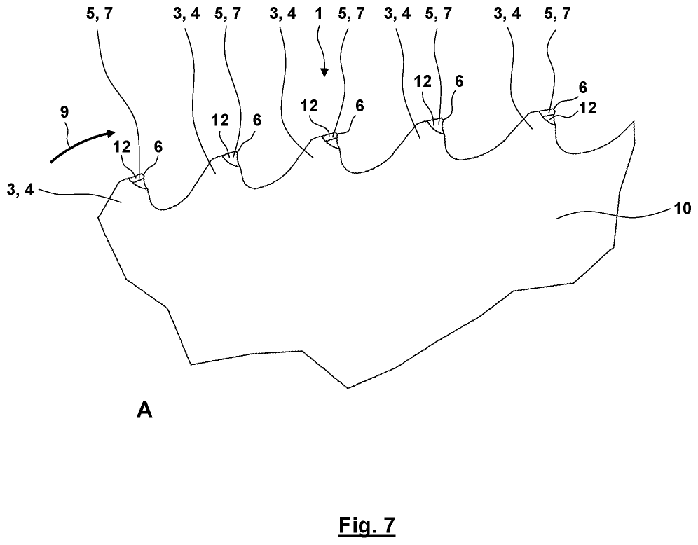

FIGS. 6 and 7 illustrate views of another exemplary embodiment of the separating tool 1. In this case, the separating tool 1 is designed as a circular saw blade.

The teeth 3 are arranged at the tooth supporting body 2 according to the group technology and with a variable tooth division (i.e. varying distances between them). Protrusions 4 are formed at the tooth supporting body 2. Inserts 5 are fixedly connected to the protrusions 4. The rake surfaces 8 have a negative rake angle. The tooth supporting body 2 is made of the superalloy 10. The tooth tips 7 and another part of the protrusions 4 our coated with the hard material layer 12.

It is to be noted that the above-described different material designs of the embodiments concerning the superalloy 10, the heat insulation layer 11 and the hard material layer 12 can also be applied to the geometries of the other embodiments.

I claim:

1. A separating tool, comprising:
a tooth supporting body, the tooth supporting body being made of a superalloy; and
a plurality of teeth, the teeth being arranged at the tooth supporting body.

2. The separating tool of claim 1, wherein the superalloy is a nickel-based superalloy.

3. The separating tool of claim 1, wherein the teeth each include a tooth tip having a geometrically defined cutting edge.

4. The separating tool of claim 3, wherein the cutting edge includes a rake surface having a negative rake angle.

5. The separating tool of claim 3, wherein the tooth tip is coated with a hard material layer.

6. The separating tool of claim 1, wherein the separating tool is a saw band.

7. The separating tool of claim 3, wherein the teeth are each formed by a protrusion and an insert, the protrusion being arranged at the tooth supporting body and the insert being arranged at the protrusion, the insert forming the tooth tip and the cutting edge of the tooth.

8. The separating tool of claim 7, wherein the protrusion is made of the superalloy.

9. The separating tool of claim 7, wherein the insert is made of carbide.

10. The separating tool of claim 7, wherein the insert is connected to the protrusion by welding or high-temperature brazing or soldering.

11. The separating tool of claim 1, wherein the teeth each include a tooth tip being partly covered by cutting particles to form geometrically undefined cutting edges.

12. The separating tool of claim 11, wherein the cutting particles include cubic boron nitride (CBN), cutting ceramics, carbide or combinations thereof.

13. The separating tool of claim 1, further comprising:
a carrier band section, the carrier band section being made of the superalloy; and
an edge wire section, the edge wire section being connected to the carrier band section, the edge wire section forming tooth tips and cutting edges of the teeth.

14. A tooth supporting body for a separating tool which includes the tooth supporting body and a plurality of teeth being arranged at the tooth supporting body, wherein the tooth supporting body is made of a superalloy.

15. Use of a separating tool, dividing tool or chipping tool including a tooth supporting body being made of a superalloy and a plurality of teeth being arranged at the tooth supporting body as a high-temperature steel-separating tool for separating a blank for a workpiece made of steel with a temperature of at least 750° C.

16. The use of claim 15, wherein separating is realized during steel production.

17. Use of a chipping tool including a tooth supporting body being made of a superalloy and a plurality of teeth being arranged at the tooth supporting body as:
an underwater workpiece separating tool for separating a workpiece underwater; or
a tool for separating a workpiece with pure water as cooling lubricant.
